(19) United States
(12) Patent Application Publication
(10) Pub. No.: US 2002/0059151 A1
(43) Pub. Date: May 16, 2002

(54) Data analysis

(76) Inventors: Majeed Soufian, Cheshire (GB); Martin Arthur Claydon, Manchester (GB)

Correspondence Address: NIXON & VANDERHYE P.C., 8th Floor, 1100 North Glebe Road, Arlington, VA, 22201-4714, US

(21) Appl. No.: 09/847,589

(22) Filed: May 3, 2001

Related U.S. Application Data
(63) Continuation of application No. PCT/GB99/03694, filed on Nov. 8, 1999.

(30) Foreign Application Priority Data
Nov. 6, 1998 (GB) 9824444.5

(51) Int. Cl. G06F 17/30

(52) U.S. Cl. 706/15; 707/3

(57) ABSTRACT

The invention relates to a method of comparing data which method comprises defining a plurality of data points in respect of each item to be compared across the complete range of data, converting each data point to a vector spatial function, said function being characteristic of the position/shape and/or relative intensity of the data at that point, assembling the vector spatial functions for the data range in question as a cluster and then determining the kernel function in respect of said cluster, determining a radial basis function for each kernel which is characteristic of all the information in that spectrum and comparing the radial base function of the cluster kernel of the sample item with the radial basis function of the cluster kernel of the other data items within the database.

This invention relates to data analysis and has particular reference to comparison of items each of which is characterised by a large number of datapoints. The problems of handling such comparisons is well illustrated by the comparison of spectral data in which each spectrum is characterised by a large number of datapoints.

Spectral data presents some difficulty in analysis since, for example, in the original analog spectral data, the intensities are not reproducible. In some spectra, the weak spectral peaks merge into the background “noise”. These problems Me particularly well illustrated by our currently pending European Patent Application No 97937712.4 which describes and claims a method and apparatus for characterizing microorganisms using matrix assisted laser desorption ionisation time of flight mass spectrometry (MALDI-TOF-MS) spectral data for a range on known microorganisms. The specification discloses that spectral data is included in a database and a sample of an unidentified microorganism is prepared and compared using suitable comparison means with the spectral data in the database.

The precision of the MALDI-TOF-MS machine is such that the mass position on each spectral peak is not exactly reproducible and a small element of “shift” for any given peak is likely to occur. This is particularly noticeable towards the high mass end of the spectrum. Existing attempts to analyze the spectral data from MALDI-TOF-MS analysis have relied on the Jacquard method. According to this method, the spectral data is analyzed at a number of datapoints, typically at a number of datapoints greater than 16 k. Each data point reports the presence or the absence of a peak at that particular point on the spectrum. The data point reports only the presence or the absence of a spectral peak and does not include any information whatsoever concerning the intensity or relative intensity of any peak located at that position. The reported information from the datapoint is stored as an absolute number within the database. Using this technique, there is no measure of relative intensity between the peaks and troughs or relative peaks within the spectrum being analyzed. Furthermore, because of the non-reproducibility of the spectral intensity, in some instances, significant but low intensity peaks will not be reported or considered. If the background noise level within the system is relatively high, significant data may be lost due to it being simply discounted. Since the data set in any particular spectrum is very large and may be of the order of 16 k or 32 k datapoints, significant and critical amounts of characterizing information would simply be discounted with a result that critical comparisons and analysis within the database cannot take place.

In a small database, the time of calculation and comparison is acceptable, but with a large database, a full comparison using the Jacquard method will take many days to complete. In order to reduce calculation times, it is necessary either to target only part of the spectral data or to discard some of the data from the total spectrum. In either case this results in a further degradation of potential accuracy, and positive identification or rejection is less likely to be obtained.

This is true for any dataset defined by a large number of datapoints, and although the invention will generally be described and exemplified with reference to spectral data, particularly MALDI-TOF-MS spectral data, it will be appreciated that this invention is applicable to any situation in which a complex series of datapoints needs to be compared or manipulated. In consequence, the invention is not limited to the comparison or manipulation of spectral data.

In the ideal analytical pattern recognition system, the system should report:

(A) this example is of class I'll or

(B) this example is from none of these classes or

(C) this example is too hard for me to consider.

The second category is called “outliners”, while the third category is referred to as “rejects” or “doubt”. Both categories of rejection have great importance in applications, particularly in medical diagnostic aids, where there is a clear need for certainty. A sample must either match, must be rejected outright, or must clearly be identified as “doubtful”.

Attempts to overcome these disadvantages have been attempted by using neural networks.

The ISIS technical report entitled “Support Vector Machines for Classification and Regression” by Steve Gunn of the University of Southampton dated May 14, 1998. This document is concerned primarily with the probelm of empirical data modelling; using a process of induction which is used to build up a model of a system from which it is hoped to deduce responses of the system that had yet to be observed. This paper is concerned with overcoming the problems of traditional neural network approaches, which are stated to have suffered difficulties with generalisation by producing models that can overfit data. The paper is concerned with the derivation of kernal functions and the means of comparison of those functions in a sample with corresponding functions in a database. In particular, the paper discloses the selection of data points, defining 8 kernel functions and then comparing kernel functions with others in a database. The problem of polynomial mapping is particularly acknowledged in that a very careful choice of kernel functions necessary to produce a satisfactory classification boundary that is topologically appropriate. It is acknowledged that while it is possible to map input space into dimensions greater than the number of training points and to produce neural network with no classification errors on the training set the fact is that such an arrangement is known to generalise badly. The paper acknowledges that computation is critically dependent upon a number of training patterns and to provide good data distribution will require a large training set.

It is well known to the man skilled in the art that trained neural networks require a considerable input of effort in the training of the network and that each additional sample within the database will require further extensive training. The present invention seeks to overcome this particular problem.

The application of analysis techniques using neural networks has been described in The Journal of Biotechnology 62 (1998) 1-10 “Analysis of differentiation state in Streptomyces albidoflavus SMF 301 by the combination of pyrolysis mass spectrometry and neural networks” teaches the morphological differentiation of SMF 301 in a batch culture analysed by pyrolysis-mass spectrometry. Cure point pyrolysis-mass spectra of all cells at various growth phases were obtained. The pyrolysis-mass spectrometry (PMS) spectra varied with growth phases and differentiation. It was possible to distinguish differntiation state with multivariate statistics and artificial neural network. Artifical neural networks were trained on PMS data to predict the differentiation state using two different algorithms; back propagation and a radial basis function classifier. Both the back propagation and the radial-basis classifier succeeded in separating the differentiation state and identified the transient state. This was achieved by statistical analysis of the spectral data using canonial variate analysis. The neural networks operated on an input vector of a plurality of values. The data was divided into training and testing sets with transient samples for validation.

A paper entitled “Introduction to multi-layered feed-forward neural networks” in Chemo metrics and Intelligent Laboratory Systems 39 (1997) 43 to 62 deals with basic definitions concerning the multi-layered feed-forward neural networks. Back-propogation training algorithms are explained and the paper discloses partial derivatives of the objective function with respect to the weight and facial coeffients derived. This paper is concerned principally with trained neural networks and with the two main types of training process both Supervised and unsupervised. The paper discusses the questions of model selection in training the problems of weight decay and the desirability or otherwise of early stopping of training. The use of neural networks in chemistry and in particular in spectroscopy are discussed.

The prior art takes use of trained neural networks which require considerable input of effort to affect the initial training. Furthermore, there is a limit to the amount of material that can be handled by such networks on the basis of the volume of kernel functions that are generated by extensive amounts of data.

For the foregoing, therefore, it will be seen that there is a need for an improved and more effective diagnostic engine for use in the analysis of, for example, MALDI-TOF-MS spectral data.

According to one aspect of the present invention, there is provided a method of comparing spectral data or like data, which method comprises defining as a group, a plurality of data points within a range of data points for a data item, converting said group of data points to at least one kernel function, assembling the resultant plurality of kernel functions covering all the data points for the data item into a cluster, and projecting said cluster of kernel functions in high dimensional space using Cover's Theorem to define a single searchable reference point for all the data points for said data item, and comparing the said single searchable point for a sample item with the single searchable point for similarly processed comparison items.

In one aspect of the invention, at least one of the groups of data paints is converted into a plurality of kernel functions.

The data may be spectral data and the datapoints may be collected across a range of spectral data. This range may extend across the whole of the spectral data or only a part or sub-set of the range.

In one aspect of the invention, data is normalized to provide an intensity function which is a measure of the relative intensity of each peak.

Where the data set is a spectrum, the data may be normalized by comparing all the peak intensities as a proportion of the highest peak which is rated at 1. All other peaks then have a value under 1. Also the norm of kernel functions in high dimensional space can be normalized to 1.

In another aspect of the present invention, the kernel functions of the spectral data is applied across a neural network. The neural network may also be employed to operate on the pattern distributions of the local kernel clusters, using the Cover Theorem (Ref: Thomas M Cover (1965) Geometrical and Statistical properties of system of linear inequalities with application in Pattern Recognition). There are points from this publication which are important in this patent:

1. A Non-linear transformation 0 of Input patterns X to a Euclidean measurement space 0:X-E^{d} which might transform a complex pattern classification problem into a linearly separable one.

2. High dimensionality of measurement space E^{d} compared to the input space: a complex pattern classification problem cast in (this) high dimensional space is more likely to be linearly separable than in a low dimension input space.

In a further aspect of the invention, the kernel functions of the spectral datapoints may be displayed as a cluster or as a single point (if the dimension of measurement space be equal to the number of datapoints, in this case, linear separability is guaranteed) in high dimensional space. The local kernel of each cluster of spectral datapoints in high dimensional space can be determined by a single set of searchable parameters.

Thus, instead of searching and comparing say 16 k datapoints for each spectrum, all that is necessary is the comparison of the unique single point references in high dimensional space for the test sample and the known controls or “database”. This has the effect of reducing the burden on the search engine while at the same time speeding up the search very considerably compared with methods hitherto employed or proposed.

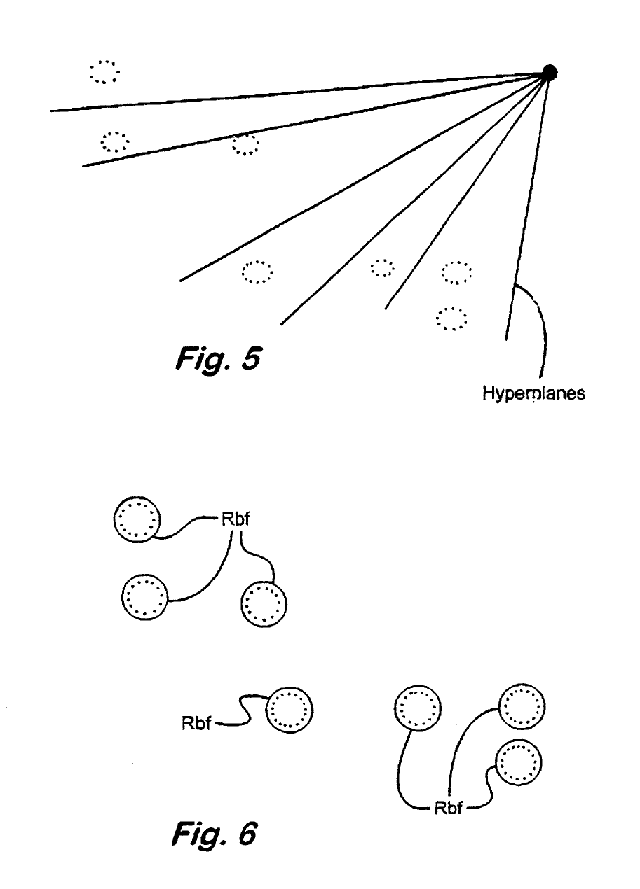

The use of an artificial neural network to assist in optimization of the search data has the advantage that prior knowledge of models and associated careful network design is unnecessary. The use of a search engine in combination with MALDI-TOF-MS spectrum to make available high-performance mass spectral analysis tool, which may be operated by the non-specialist. The equipment required to perform the analysis is relatively inexpensive, and the search engine forming part of the invention enables rapid and easy searching of an extensive database of microorganisms. Prior art multilayer perceptor neural networks use hyperplane to separate cluster kernels (see FIG. 5). In our approach radial basis functions (Rbf) are used to fit or include each cluster kernel (FIG. 6).

The invention also includes a method of characterizing microorganisms which method comprises:

providing a database of MALDI-TOF-MS spectral data for a range of known microorganisms,

preparing a sample of unidentified microorganisms and obtaining the MALDI-TOF-MS spectral data thereof

and comparing, using suitable comparison means, the spectral data so obtained with spectral data contained in the database, thereby to identify a known microorganism having the same or similar spectral data,

characterized in that the comparison means comprises the steps of:

defining a plurality of datapoints in the spectrum across the complete range of the spectral data, converting groups of datapoints to a kernal function, said function being characteristic of the position, shape and relative intensity of the spectral data at that point,

assembling the kernal functions for the spectrum in question as a cluster and then projecting or mapping is said kernel functions in high dimensional space cluster (see FIG. 1),

to define a searchable function in a high dimensional space which is characteristic of all the information in that spectrum,

and comparing that searchable function with the corresponding function of all the other data within the database.

The database in accordance with the present invention may comprise the radial basis functions of the kernel of each cluster of spectral data in high dimensional space for each microorganism.

In this way, none of the information relating to the spectrum is lost or discarded: and all of the spectral information is included in the resulting radial basis function of the cluster of searchable points relating to that particular microorganism in high dimensional space. This means that the spectral data may be recorded in digital form for ease of searching with only a simple radial basis function defining the cluster for the samples of a given microorganism representing the standard deviation of the samples in the group from a mean. The presence and availability of all the data points within the cluster for each spectrum permits the re-constitution of each microorganism from this information so that spectral data may be re-presented in graphic as well as digital or numeric form.

The invention also includes a database comprising the radial basis functions of the known microorganisms for comparison with the organisms themselves.

Following is a description by way of example only of one method of carrying the invention into effect.

In the drawings:

FIG. 1 is a map representation of a microorganism spectrum to a high dimensional space and shows a local kernel function of the spectrum.

FIG. 2 is a 2-dimensional illustration of the radial basis function for each cluster of the local kernel function.

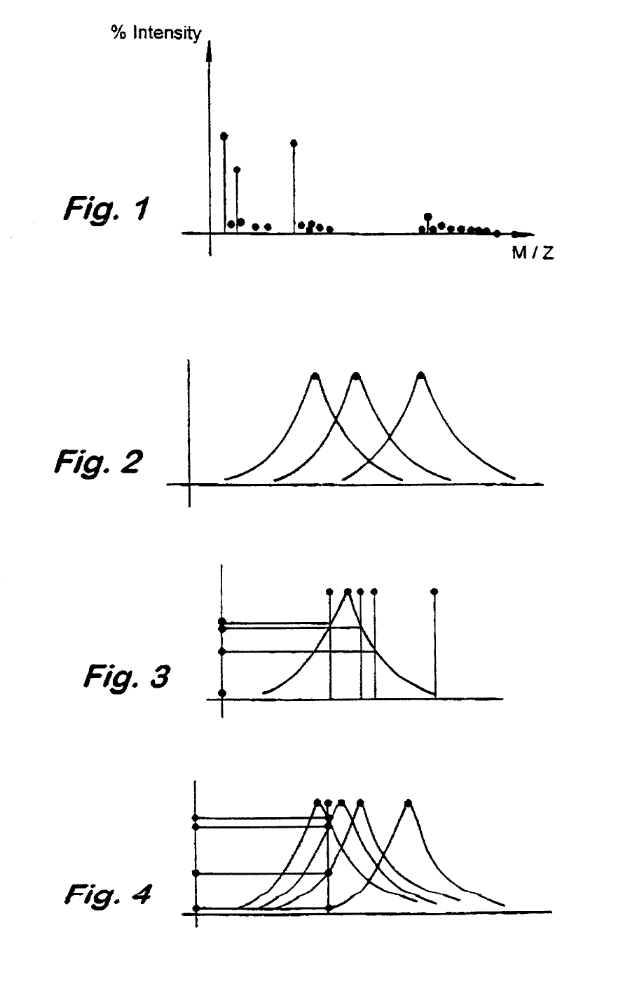

FIG. 3 is a 2-dimensional illustration of a comparison of the radial basis function of the cluster kernel function of an unknown sample with the other local kernel functions

FIG. 4 is a 2-dimensional illustration of comparison the local kernel function of an unknown sample with each radial basis function of cluster kernel in database.

FIG. 5 is a 2-dimensional illustration of the hyperplanes of a multilayer perceptron neural networks used in clustering of some data.

FIG. 6 is a 2-dimensional illustration of the radial basis function neural networks used in clustering of some data.

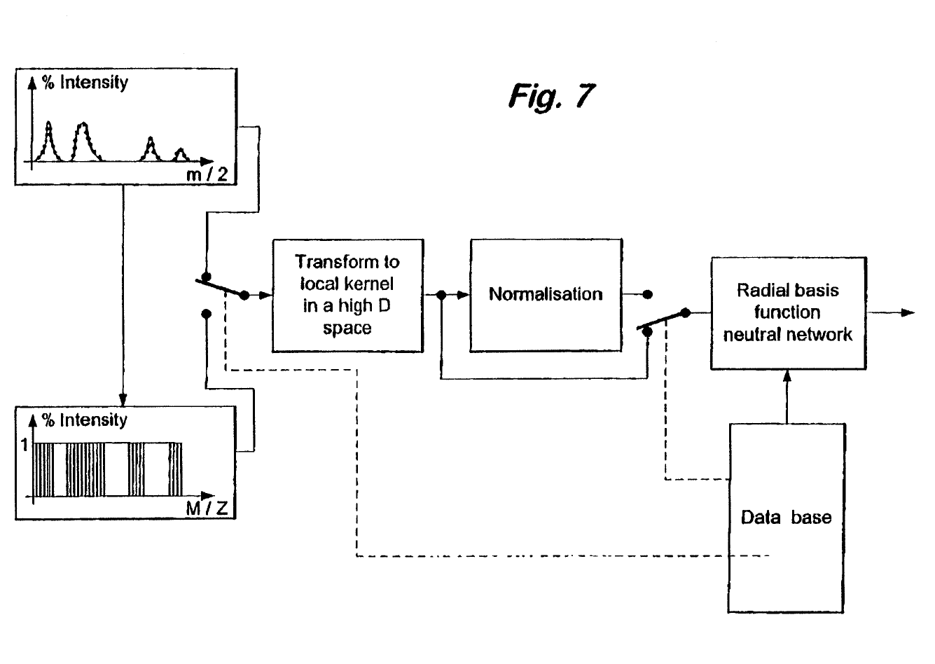

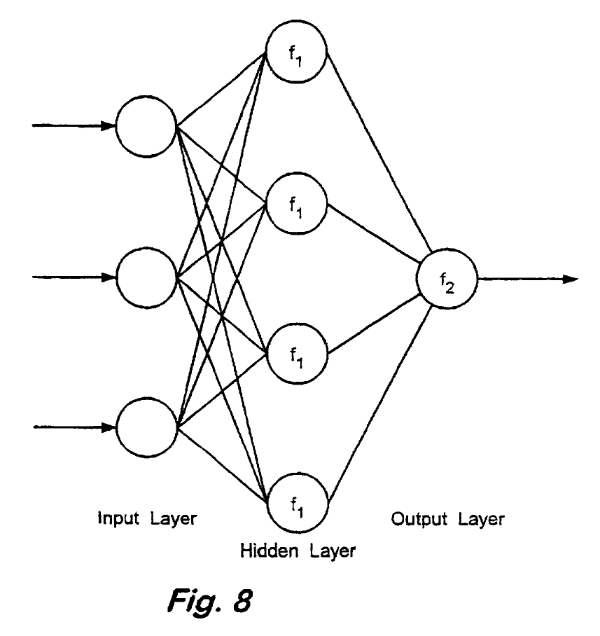

FIG. 7 is the block diagram for typing and identifying of microorganisms using their MOLDI TOF pectrums

FIG. 8 is a schematic representation of a neural network for use in the present invention.

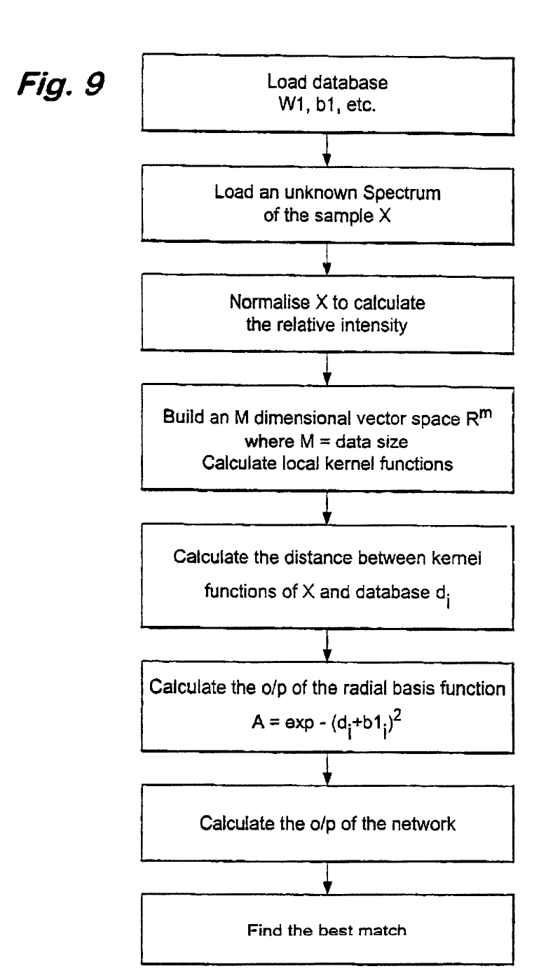

FIG. 9 is an algorithm for arriving at the radial basis function for any particular spectrum.

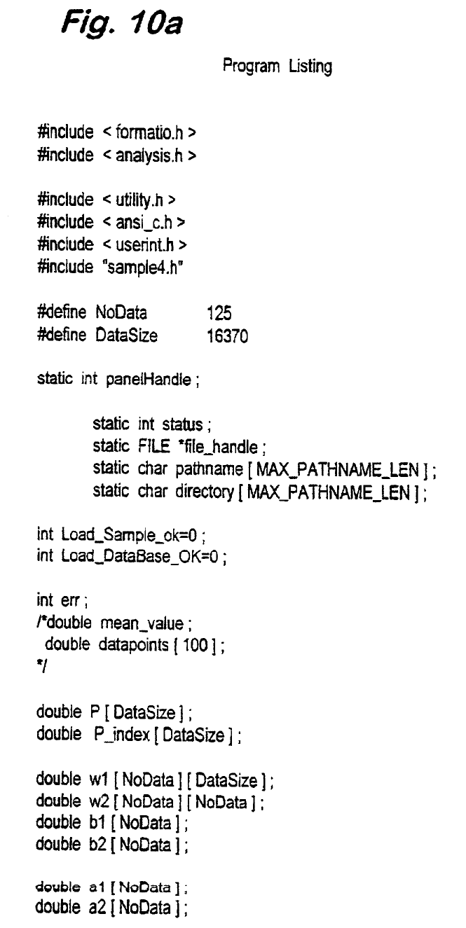

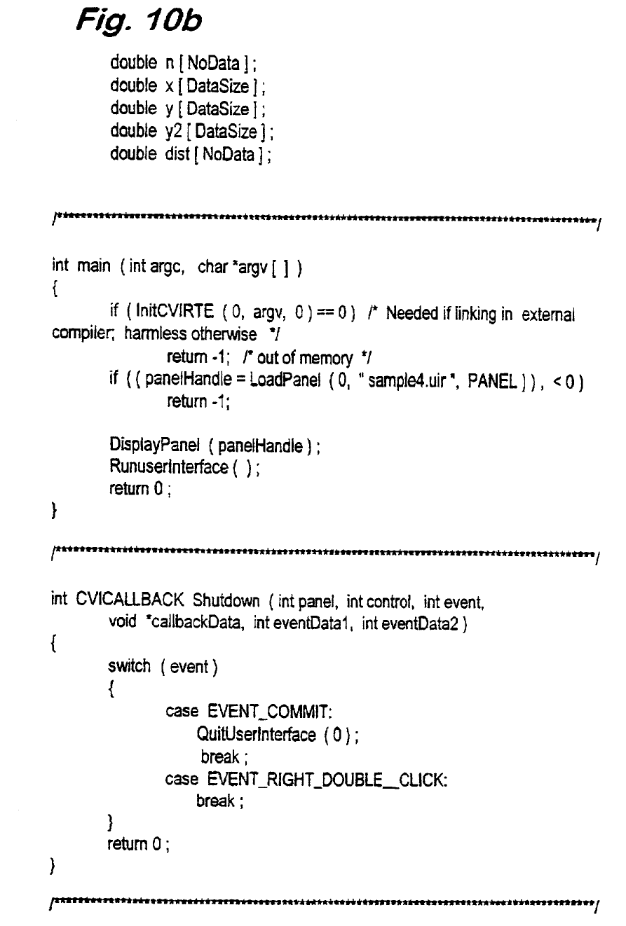

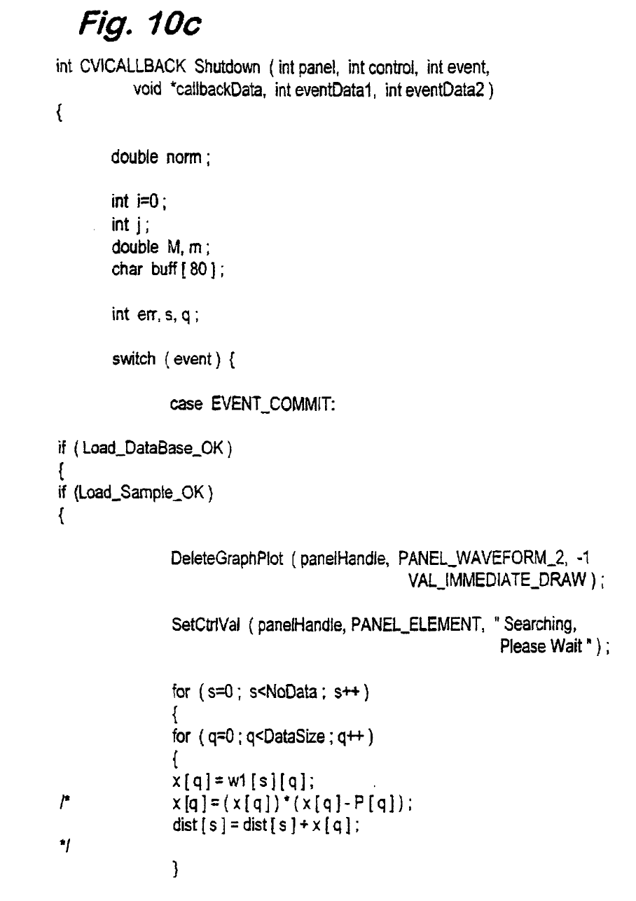

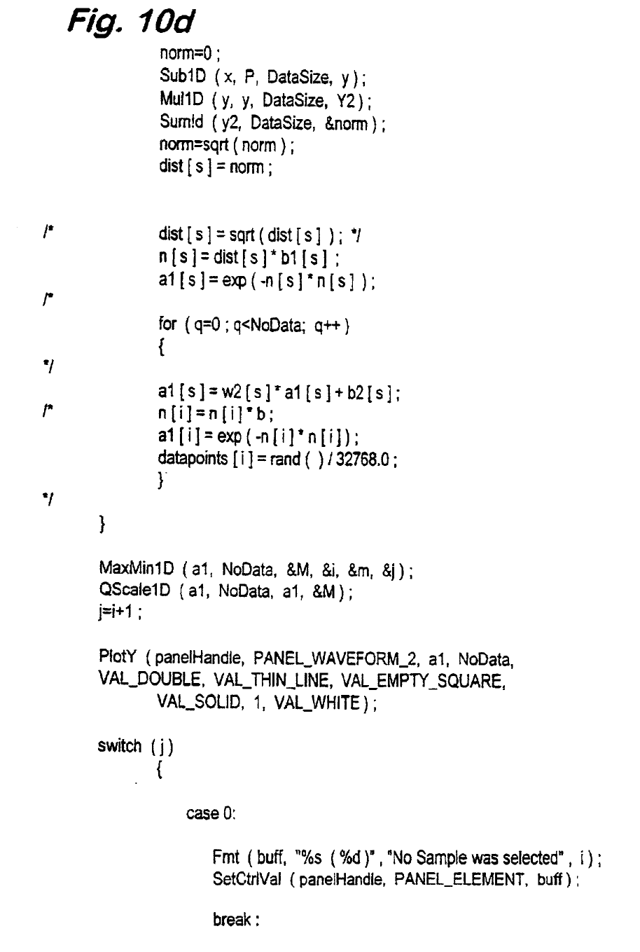

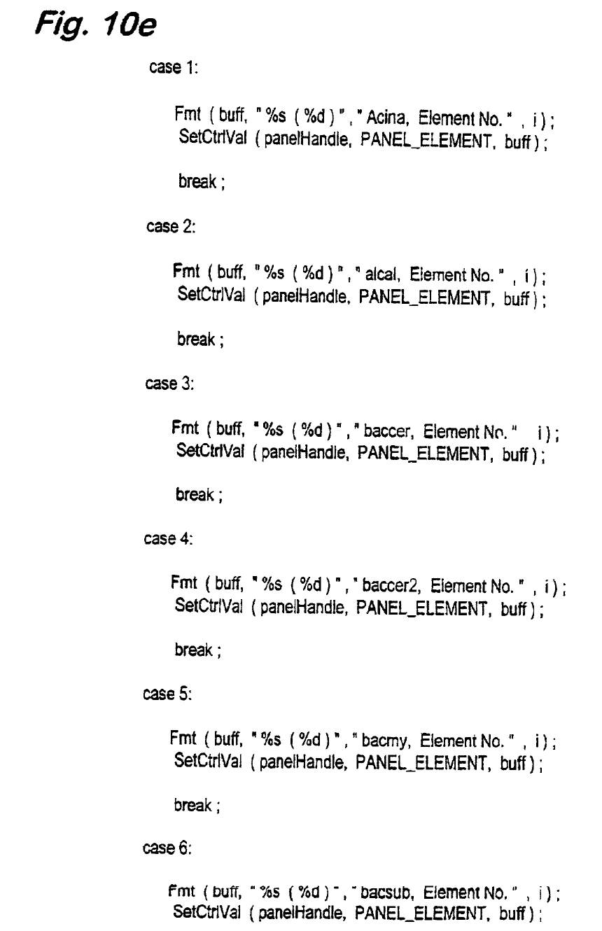

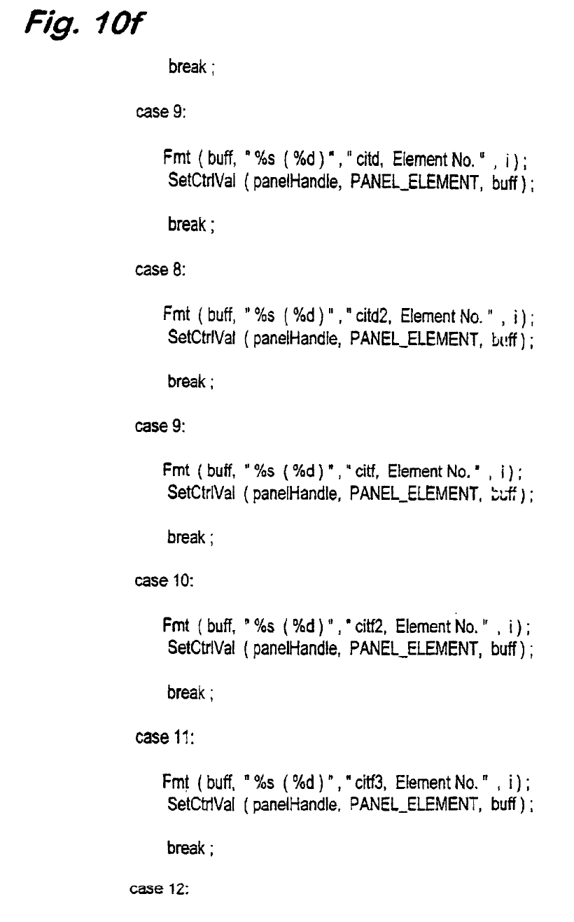

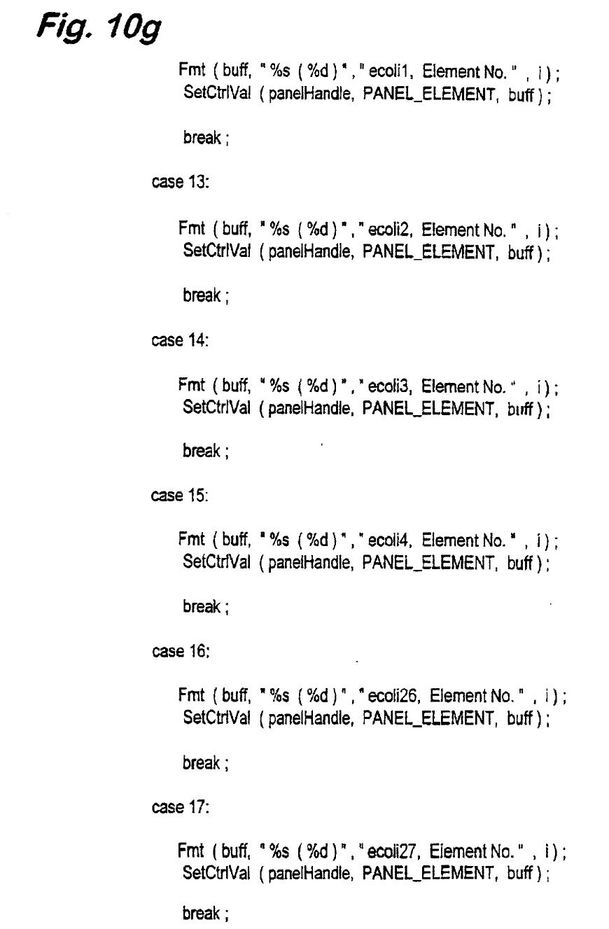

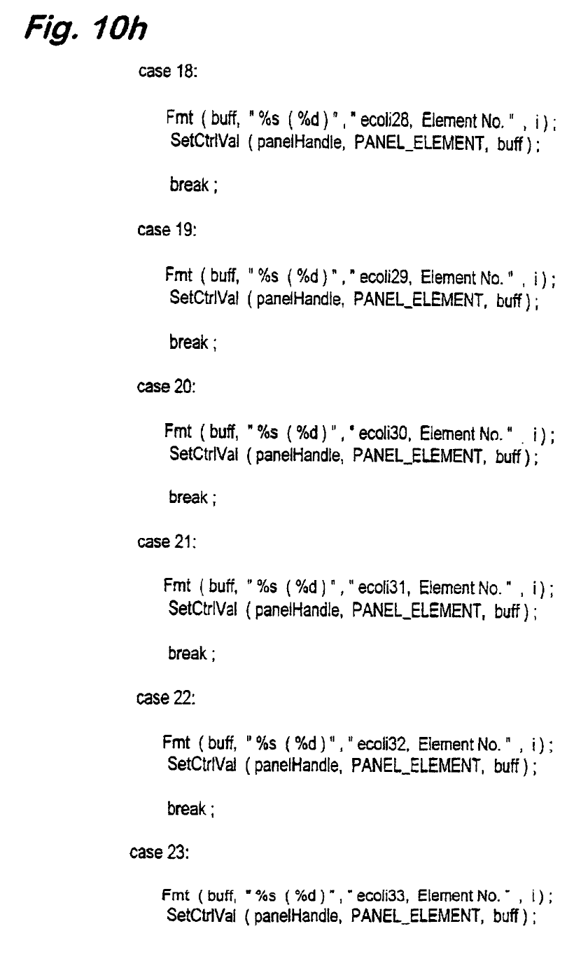

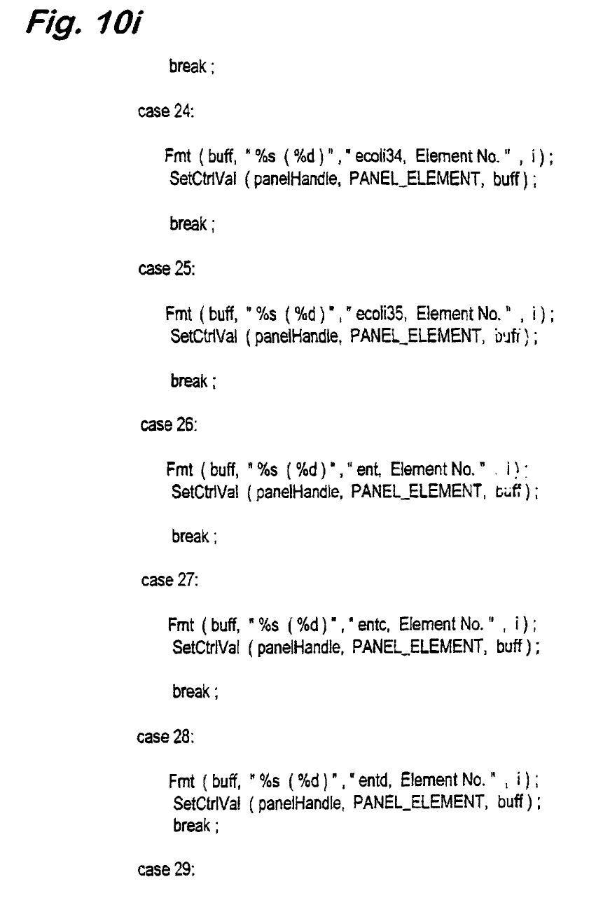

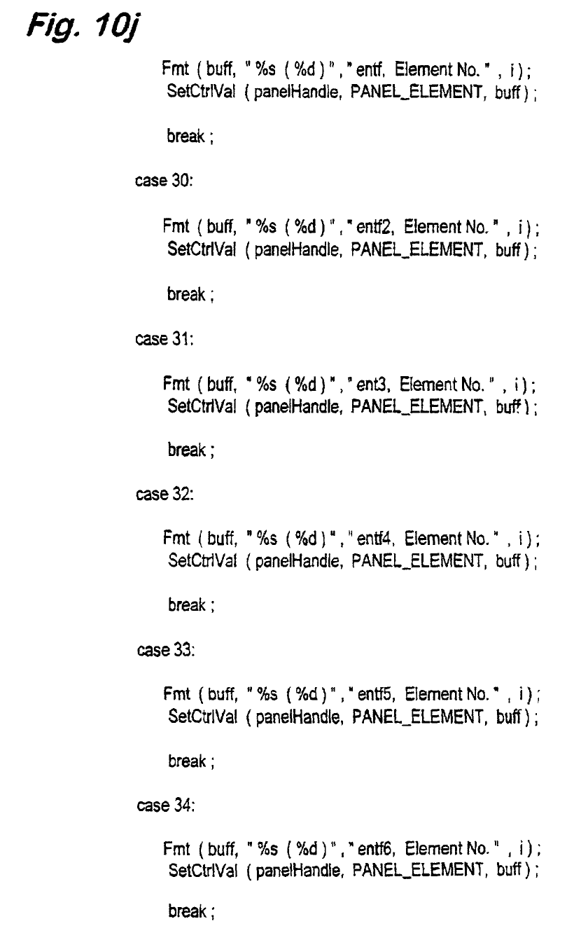

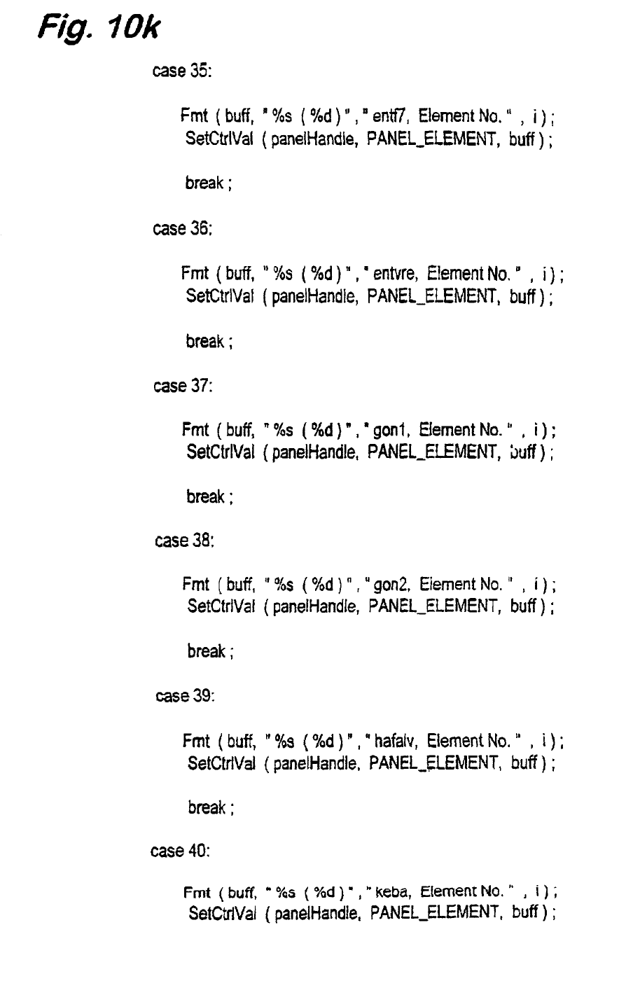

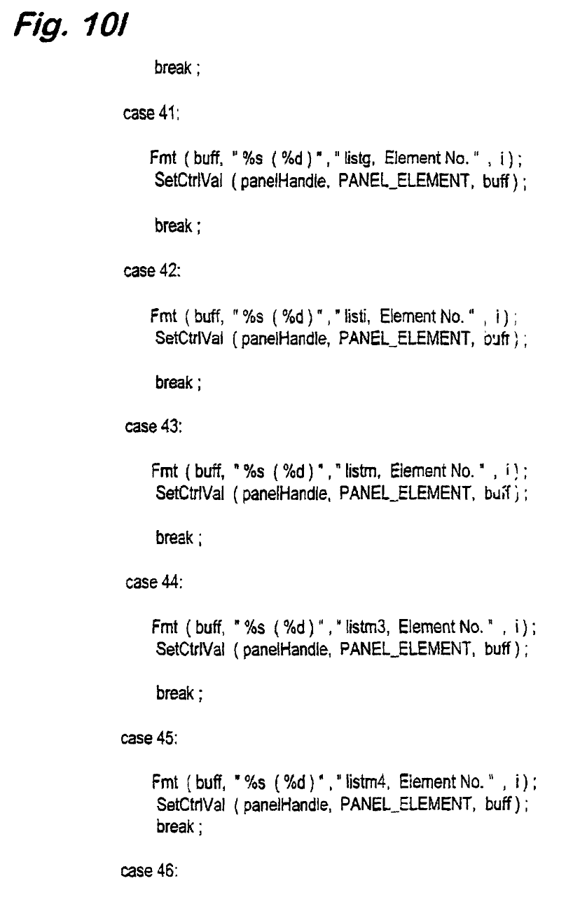

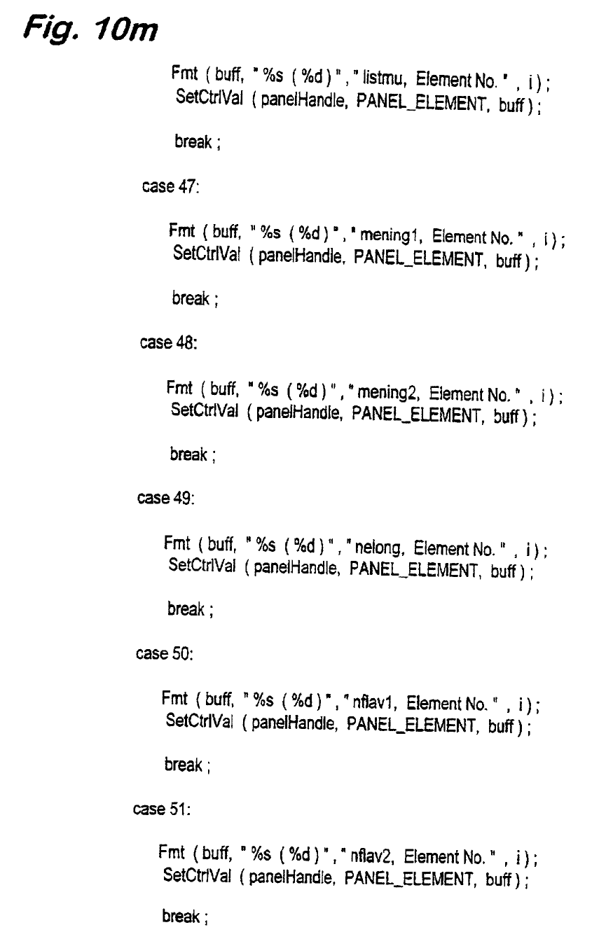

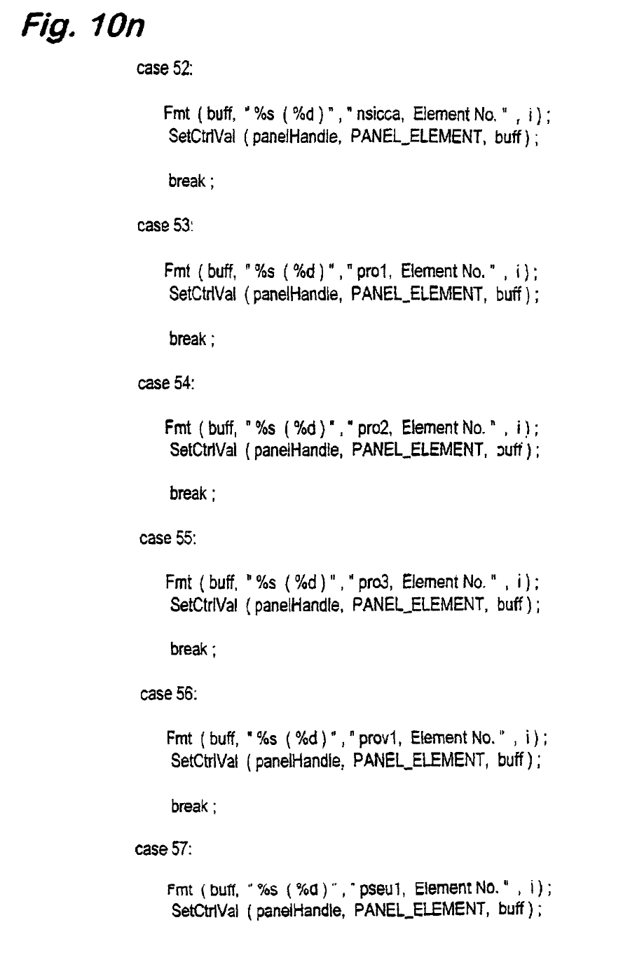

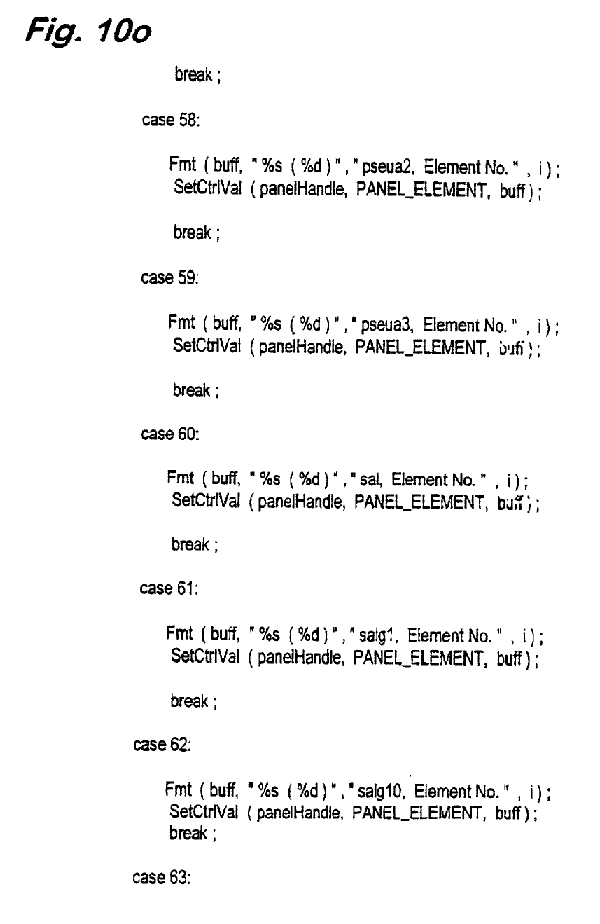

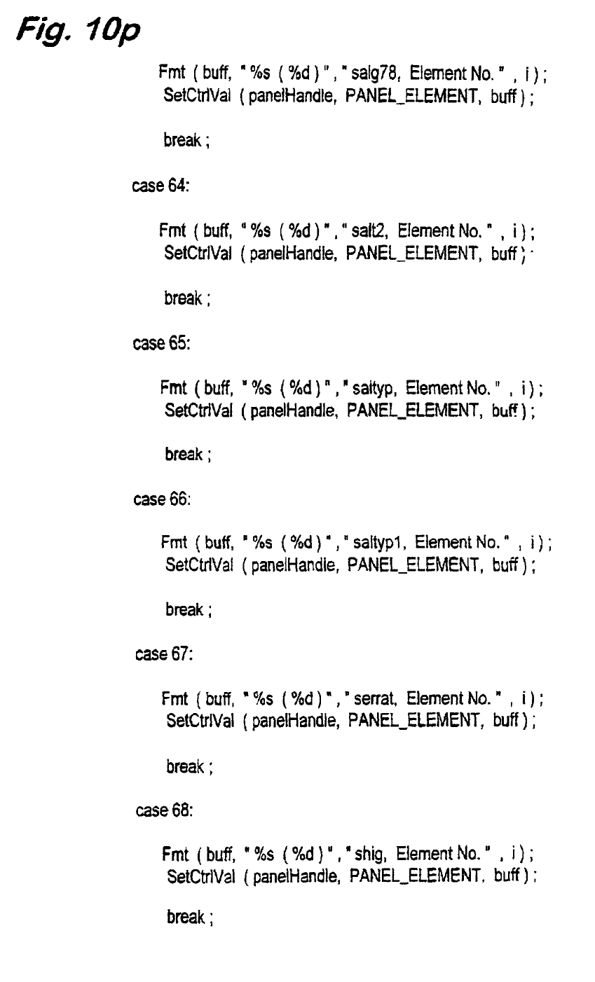

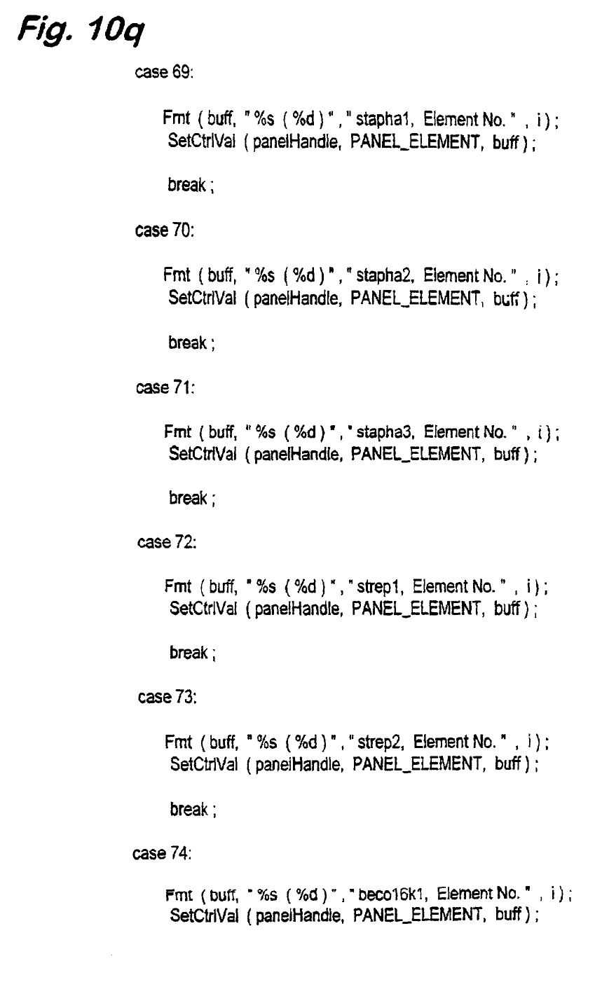

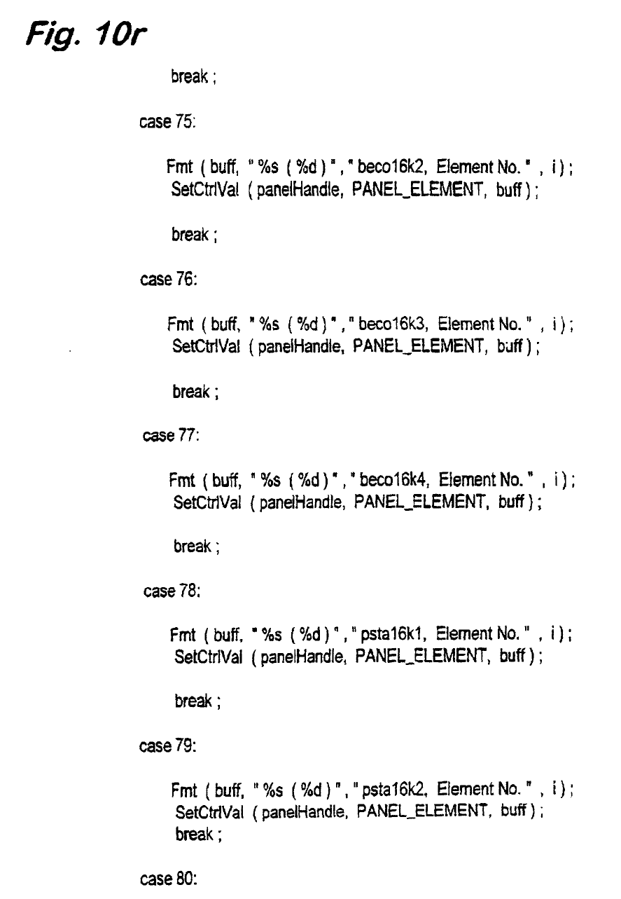

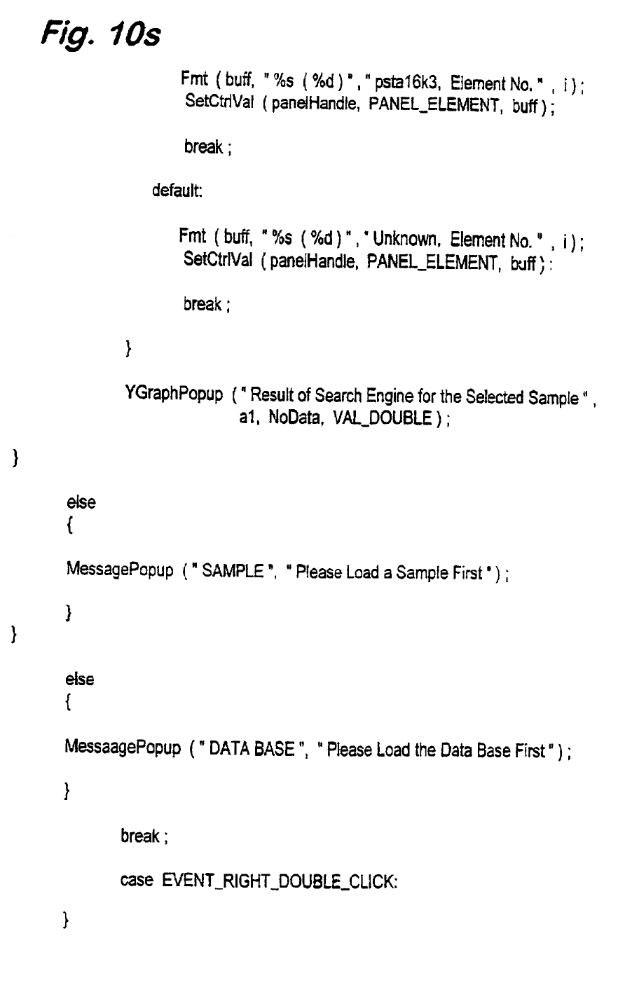

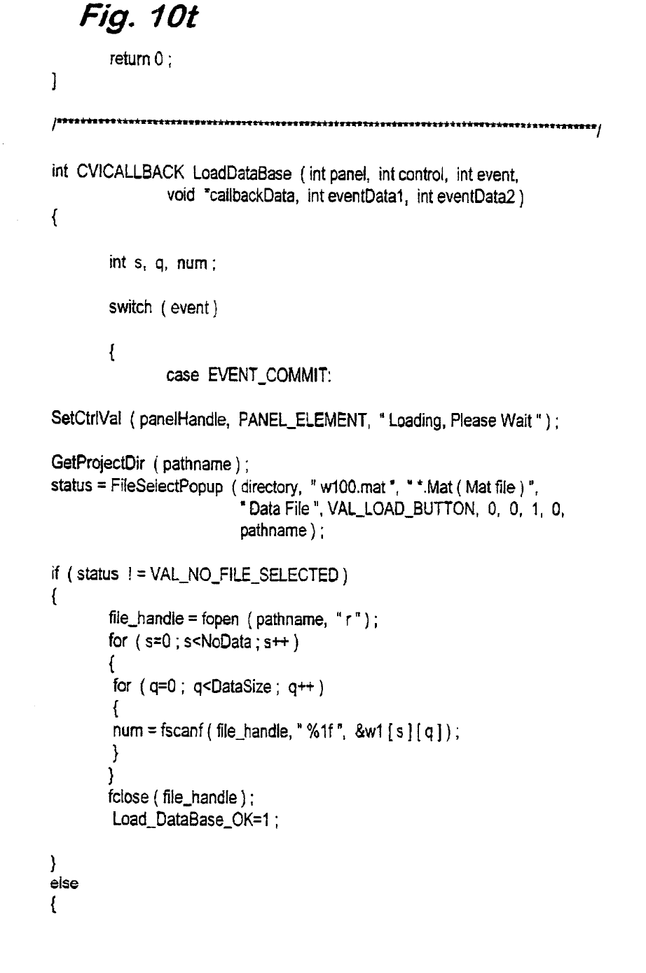

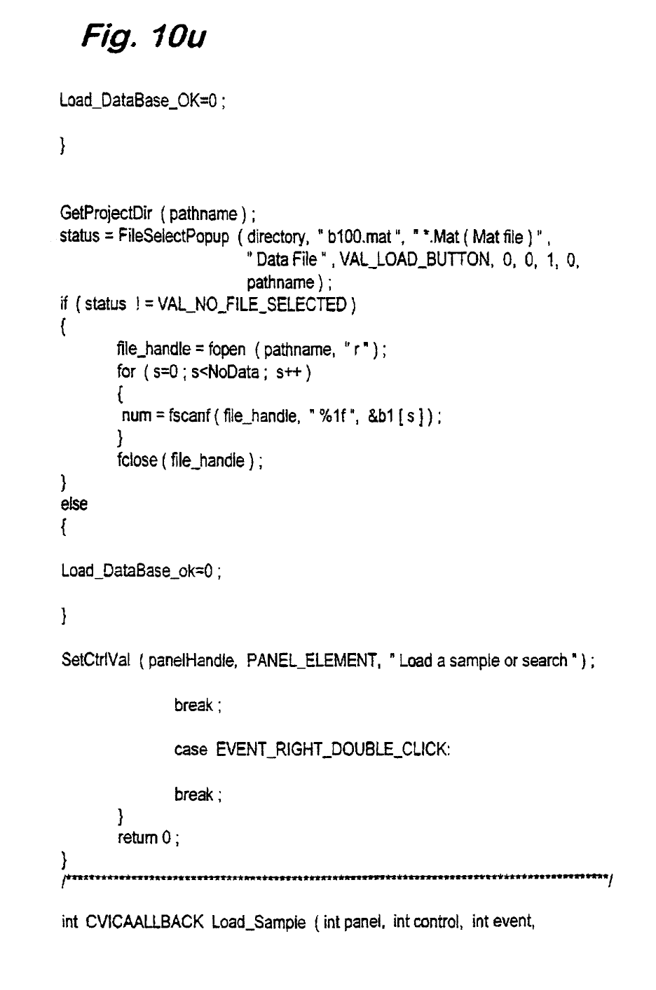

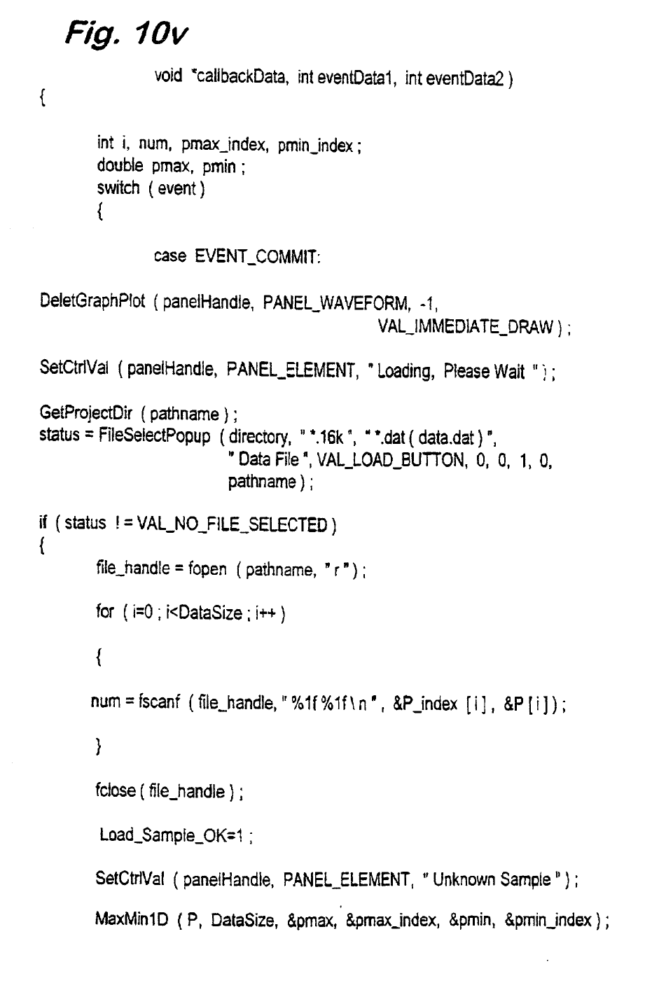

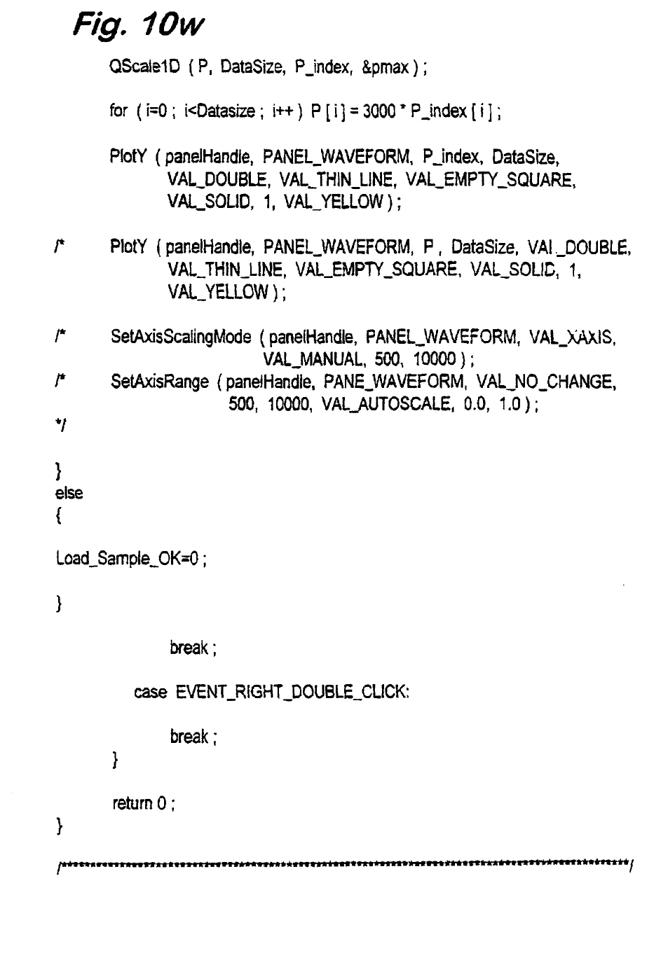

FIG. 10 is the detail of a program for use in the analytical process of the present invention.

The drawing of FIG. 8 is a schematic representation of a neural network, which can be adapted for use in the apparatus of the present invention. In this case, the radial basis function of the kernel of the cluster of spectral data in respect of the sample is fed into the output neurone. This information is processed by a multitude of processors in the output layer and is presented at the output of neural networks. In the example shown in FIG. 8, a single output neurone is shown as the output layer. In accordance with the present invention, a multitude of output neurones would be provided, one in respect of each sample in the database available for comparison. The processed radial basis function data is provided at each of the output neurones and is compared with the local kernel function data for the sample with the corresponding function for each microorganism spectrum within the database. The degree of similarity or overlap can be determined by using a spreading factor which characterise each cluster. An exact match or a very close match will result in a clear identification of the sample microorganism.

Where there is no direct correspondence in high dimensional space between the data cluster for a sample with other data clusters in the database, then a vector will be presented detailing the clusters in high dimensional space nearest to the radial basis function of the sample. This will give an indication of the degree of similarity or overlap between the unknown sample and known similar spectra within the database. This will enable the analyst to call up the graphic data relating to the particular “close matches” and to compare them visually.

It will be appreciated by the person skilled in the art that the radial basis function of the cluster in respect of a given sample in high dimensional space will be a result of all the features of each data point within each sample (spectrum) constituting the clusters of samples and that the radial basis function will be determined, spatially, by the individual values of the vector functions of each sample point in high dimensional space. Thus several similar microorganisms that are not identical may reside in the same proximate area of high dimensional space. The relative position of each sample will be determined by the extent of the differences in their spectral details. If the microorganisms are of the same genus then the two reference points defined by the spectral clusters will substantially coincide, and the greater the extent of the overlap the greater the similarity of the microorganisms.

FIG. 9 is an algorithm for determining the vector function of the point in HDS for the kernel cluster of any given spectrum

FIG. 10 is the detail of a computer program for performing the algorithm of FIG. 9.

As a result of Cover's theorem, a non-linear transformation might transform a complex pattern classification problem into a linearly separable one. Also by using transformations in possibility theory (fuzzification and defuzzification), uncertainty in a population of patterns will be resolved. These transformations also increase the dimensionality of pattern space which according to Cover's theorem results are desirable too.

1. A method of comparing spectral data or like data, which method comprises defining as a group, a plurality of data points within a range of data points for a data item, converting said group of data points to at least one kernel function, assembling the resultant plurality of kernel functions covering all the data points for the data item into a cluster, and projecting said cluster of kernel functions in high dimensional space using Cover's Theorem to define a single searchable reference point for all the data points for said data item, and comparing the said single searchable point for a sample item with the single searchable point for similarly processed comparison items.

2. A method as claimed in claim 1 characterised in that at least one of the groups of data points is converted into a plurality of kernel functions.

3. A method as claimed in claim 2 wherein the single searchable reference point is defined by a vector function.

4. A method as claimed its claim 1 wherein variables in data points within an item define a radial basis function for the said single searchable point which constitute a measure of the spread of said variables for that item about a mean.

5. A method as claimed in claim 1 wherein uncertainty in the comparison of points is resolved using transformations in possibility theory.

6. A method as claimed in claim 1 wherein the data points are selected across a range of data, in which the data is normalized by comparing all the data magnitudes as a proportion of the highest, which is rated at 1.

7. A method as claimed in claim 1 Wherein the data is spectral data.

8. An apparatus for screening of microorganisms characterised by spectroscopic means for producing spectral data of the sample organism database means containing spectral data for a range of microorganisms and comparison means for comparing the spectral data of the sample with that of the database to permit classification/identification of the sample, characterized in that the spectroscopic means comprises means for producing spectral data of the sample organism by MALDI-TOF techniques and in that the database contains MALDI-TOF-MS spectral data, and in that the comparison means is a method as claimed in claim 1.

9. Apparatus as claimed in claim 8 wherein the spectral data in the database is arranged in groups of data according to the genus of each microorganism with sub-divisions corresponding to each strain of microorganism.

10. Apparatus as claimed in claim 8 characterised in that the sample of unidentified microorganism is prepared by a technique selected from the group consisting of (i) taking cells from a culture and applying them to a sample plate comprising a matrix and (ii) by admixing the cells with the matrix prior to subjecting to MALDI-TOF-MS analysis in order to retain the cellular integrity of the sample.

11. Apparatus as claimed in claim 6 characterised by means for bombarding a sample matrix mixture with laser energy to create a gas phase ionic species which is then pulsed into a flight conduit or tube for identification of both positive and/or negative ions.
